(19) United States
(12) Patent Application Publication
(10) Pub. No.: US 2015/0159502 A1
(43) Pub. Date: Jun. 11, 2015

(54) EXHAUST GAS TURBOCHARGER, IN PARTICULAR FOR A MOTOR VEHICLE

(71) Applicant: Bosch Mahle Turbo Systems GmbH & Co. KG, Stuttgart (DE)

(72) Inventors: Jochen Laubender, Ingolstadt (DE); Marcus Schneider, Kornwestheim (DE)

(21) Appl. No.: 14/556,789

(22) Filed: Dec. 1, 2014

(30) Foreign Application Priority Data
Nov. 29, 2013 (DE) 102013224572.6

(51) Int. Cl. F01D 17/16

(52) U.S. Cl. CPC F01D 17/165; F05D 2250/90; F05D 2250/42; F05D 2220/40; F05D 2250/74

(57) ABSTRACT

An exhaust gas turbocharger may include a turbine housing and a turbine wheel. The turbine wheel may include a first quantity of a plurality of moving blades. The turbine wheel may be rotatable relative to the turbine housing about a turbine wheel centre of rotation and have a turbine wheel radius. A variable turbine geometry may include a blade bearing ring on which a second quantity of a plurality of guide blades are rotatably mounted in each case about a guide blade centre of rotation. The plurality of guide blades may be adjustable between a closed position, in which a flow cross section between the guide blades for an exhaust gas to flow through is at a minimum, and an opened position, in which the flow cross section is at a maximum.

### CROSS-REFERENCE TO RELATED APPLICATIONS

This application claims priority to German Patent Application No. 10 2013 224 572.6, filed Nov. 29, 2013, the contents of which are hereby incorporated by reference in their entirety.

### TECHNICAL FIELD

The present invention relates to an exhaust gas turbocharger, in particular for a motor vehicle, and to a motor vehicle having such an exhaust gas turbocharger.

### BACKGROUND

As is known, exhaust gas turbochargers for internal combustion engines consist of two flow machines: on the one hand of a turbine, on the other hand of a compressor. The turbine utilises the energy contained in the exhaust gas for driving the compressor, which sucks in fresh air and introduces compressed air into the cylinders of the internal combustion engine. Because of the usually very high rotational speed range of the internal combustion engine, controlling the exhaust gas turbocharger is required so that as constant as possible a charge pressure can be ensured in as large as possible a rotational speed range of the internal combustion engine. Solutions are known for this according to which a part of the exhaust gas flow is conducted about the turbines by means of a bypass channel. However, the so-called variable turbine geometry makes possible an energetically more favourable solution with which the dynamic pressure behaviour of the turbine can be continuously varied and thus the entire exhaust gas utilised in each case. Such variable turbine geometry is conventionally realised by means of adjustable guide blades, with the help of which the desired exhaust gas flow through an exhaust gas turbocharger can be variably adjusted.

Invariable turbine geometries with adjustable guide blades it proves to be problematic that through the tapering channels between the guide blades the pulsating exhaust gas ejections of the engine are accelerated and strike the blades of the turbine wheel with a greater impulse, which can lead to the excitation of natural oscillations in the turbine wheel blades proper, and over the running period lead to fatigue fractures and thus destruction of the turbocharger.

### SUMMARY

The present invention therefore deals with the problem of showing new ways in the development of variable turbine geometries and in the process provide in particular a variable turbine geometry that has improved thermodynamic efficiency.

This object is solved through the subject of the independent patent claims. Preferred embodiments are subject of the dependent patent claims.

Accordingly, the basic idea of the invention is to equip an exhaust gas turbocharger with a variable turbine geometry comprising guide blades, wherein the guide blades are adjustable between a closed position, in which a flow cross section between the guide blades for exhaust gas to flow through is minimal and an opened position, in which this flow cross section is maximal. Each guide blade in the longitudinal profile has a first profile nose facing away from the turbine wheel centre of rotation and a second profile nose facing the turbine wheel centre of rotation, the straight connecting line of which defines a profile chord. According to the invention, the spacing R_{TE} of the second profile nose from the turbine wheel centre of rotation in the opened position of the guide blades and the radius of the turbine wheel R_{TR} satisfy the following relationship:

1.03≦R_{TE}/R_{TR}≦1.06.

The design configuration of the exhaust gas turbocharger according to the invention diminishes undesirable excitation oscillations or oscillation loads on the various components to a considerable degree, which has a positive effect on the thermodynamic efficiency of the exhaust gas turbocharger. At the same time, the adjusting forces needed for moving the guide blades are minimised. The hysteresis behaviour of the variable turbine geometry is also improved, as a result of which good control behaviour can be achieved.

Particularly advantageous with respect to the efficiency to be achieved proves to be an embodiment, in which the spacing R_{TE} and the radius R_{TR} satisfy the following relationship:

1.04≦R_{TE}/R_{TR}≦1.06,

preferentially 1.05≦R_{TE}/R_{TR}≦1.06.

Particularly practically, the centre line in the longitudinal profile of the guide blade is subdivided by the guide blade centre of rotation into a first chord with chord length L₁ and a second chord with chord length L₂. The first chord is defined according to this version by a connecting straight line of the guide blade centre of rotation with the first profile nose and the second chord by a connecting straight line of the guide blade centre of rotation with the second profile nose.

A particularly high efficiency of the exhaust gas turbocharger is now achieved when the guide blades are designed in such a manner that exhaust gas entering the turbine housing strikes the guide blade at an inflow angle α≦4° relative to the first chord when the guide blades are in their closed position.

In a preferred embodiment, the angle ξ₂ between a connecting straight line connecting the turbine wheel centre of rotation and the second profile nose and the first chord are in the following angle interval:

35°≦ξ₂≦55°, in the case that the guide blades are in the opened position, and

95°≦ξ₂≦110°, in the case that the guide blades are in the closed position.

In a further particularly preferred embodiment, the angle ξ₁ between a connecting straight line connecting the turbine wheel centre of rotation and the second profile nose and the second chord satisfy one of the two following relationships:

1.4≦ξ₂/ξ₁≦1.6, or

1.2≦ξ₂/ξ₁≦1.4.

Advantageously, the angle χ formed with respect to the turbine wheel centre of rotation as apex point between two adjacent guide blade centres of rotation P and the opening angle κ of a moving blade in longitudinal section obey the following relationship:

0.4≦χ/κ≦2.4,

preferentially 0.6≦χ/κ≦1.7,

most preferentially 0.9≦χ/κ≦1.2.

In an advantageous further development of the exhaust gas turbocharger according to the invention, the length S₂ of the connecting line of two adjacent second profile noses in the opened state of the guide blades and the inlet width S₃ between two adjacent moving blades obey the following relationship:

0.45≦S₂/S₃≦3.2,

preferably 0.65≦S₂/S₃≦1.7,

most preferably 0.92≦S₂/S₃≦1.25.

In another preferred embodiment, the ratio of a flow area A_{TR} between two moving blades with respect to the inlet area A_{LS} between two guide blades obeys the following relationship:

0.36≦A_{LS}/A_{TR}≦3.82,

preferentially 0.52≦A_{LS}/A_{TR}≦2.05,

most preferably 0.74≦A_{LS}/A_{TR}≦1.5.

Here, the inlet area A_{TR} between two guide blades is defined by the relationship A_{TR}=h_{TR} S₃ and the inlet area A_{LS} between two guide blades by the relationship A_{LS}=h_{LS} S₂. Here, h₂ is the height of the guide blade along its axis of rotation and h₃ the height of the moving blade on the turbine wheel inlet.

Particularly favourable in terms of flow dynamics is an embodiment in which the ratio of the height h_{TR} of a moving blade with respect to the height h_{LS} of a guide blade satisfies the following relationship:

0.8≦h_{LS}/h_{TR}≦1.2,

preferentially 0.9≦h_{LS}/h_{TR}≦1.1.

According to an advantageous further development, the ratio of a diameter D_{TR} of a moving blade with respect to the height h_{TR} of the moving blade obeys the following relationship:

0.1≦h_{TR}/D_{TR}≦0.2,

preferentially 0.12≦h_{TR}/D_{TR}≦0.18,

most preferably 0.13≦h_{TR}/D_{TR}≦0.16.

According to another advantageous further development, an overlap Δ of two adjacent guide blades in the closed position and the length of a guide blade L_{LS} satisfies the following relationship:

0.05*L_{LS}≦Δ≦0.4*L_{LS},

preferentially 0.1*L_{LS}≦Δ≦0.3*L_{LS},

most preferentially 0.15*L_{LS}≦Δ≦0.2*L_{LS}.

Particularly favourable in terms of production prove to be two embodiments in which the exhaust gas turbocharger comprises 11 guide blades and 9 moving blades or 13 guide blades and 11 moving blades.

In a particularly preferred embodiment, the origin of a Cartesian coordinate system is defined by the first profile nose facing away from the turbine wheel. An X-direction of the Cartesian coordinate system is defined by the profile chord, wherein accordingly a Y-direction of the Cartesian coordinate system extends orthogonally to the X-direction away from the first profile nose. The guide blades in longitudinal profile each have a profile bottom side which in each case is formed concave in sections and convex in sections each with a low point P₁ and a high point P₂ and in each case a convexly formed profile top side with a high point P₃. The spacing xₚ between first profile nose and the guide blade centre of rotation P and the spacing x₁ between a profile nose and the low point P₁ satisfy the following relationship in X-direction:

(xₚ−x₁)/xₚ>0.8.

In addition, the spacing x₁ and the spacing y₁ between a first profile nose and the low point P₁ in Y-direction satisfy the following relationship:

y₁/x₁≦0.4.

To further reduce the aerodynamic forces acting on the guide blades, the guide blades in a preferred embodiment each have a profile bottom side in the longitudinal profile that is formed concave in sections and convex in sections each with a low point P₁ and a high point P₂. Furthermore, the guide blades each have a convexly formed profile top side with a high point P₃. Here, the origin of a Cartesian coordinate system is defined by the first profile nose facing away from the turbine housing and an X-direction of said Cartesian coordinate system is defined by the profile chord. The Y-direction of the Cartesian coordinate system extends away from the first profile nose orthogonally to the X-direction. According to this embodiment, the spacing xₚ between a first profile nose and the guide blade centre of rotation P in X-direction and the spacing x₁ between first profile nose and the low point P₁ each satisfy the following relationship:

(xₚ−x₁)/xₚ>0.8;

At the same time, the spacing x₁ and the spacing y₁ between first profile nose x₁ and the low point P₁ satisfy the following relationship in Y-direction:

y₁/x₁<0.4.

In an advantageous further development, a centre line is defined in the longitudinal profile by a plurality of construction circles, wherein for the radius of the first construction circle defining the first profile nose one of the two satisfies the following relationships:

r/xₚ>0.08 or r/xₚ<0.045.

The construction circles in this case lie with their centre point on the centre line and are tangent to the profile bottom side and top side.

Particularly practically, the following relationships apply in longitudinal profile of a guide blade for the diameter k₁ of a first construction circle assigned to the first profile nose, to the diameter k₂ of one of the first construction circles assigned to the second profile nose and the construction circle with maximum diameter kₘₐₓ:

1≦kₘₐₓ/k₁≦20, and

1≦kₘₐₓ/k₂≦10.

In a particularly advantageous embodiment, which further improves the efficiency of the exhaust gas turbocharger with variable turbine geometry, the following relationships are satisfied:

0.03≦r/xₚ, preferentially 0.07≦r/xₚ,most preferably 0.11≦r/xₚ.

In a particularly preferred embodiment, the following relationship applies to the guide blade geometry: r/xₚ≦0.4, preferentially r/xₚ≦0.38, most preferentially r/xₚ≦0.35.

According to a further particularly practical embodiment, the X and Y-coordinates of the following points are defined in the Cartesian coordinate system:
xₚ, yₚ: Cartesian coordinates of the guide blade centre of rotation P,
x₁, y₁: low point P₁ of the convex profile bottom side,
x₂, y₂: height P₂ of the concave profile bottom side,
x₃, y₃: height P₃ of the convex profile top side,
x₄, y₄: high point P₄ of the centre line,
x₅, y₅: first intersection P₅ of the convex profile bottom side with the profile chord,
x₆, y₆: second intersection P₆ of the concave profile bottom side with the profile chord.

Here, the following relationships apply to the low point P₁ and the high point P₂ and to the centre of rotation P:

0≦yₚ/y₄≦2,

0≦yₚ/y₁≦5,

0≦y₂/yₚ≦0.7, and

0≦y₃/y₁≦5.

In a preferred embodiment in order to further reduce the aerodynamic forces acting on the guide blades, a length L_{Profile chord} of the profile chord satisfies the following relationship:

0.3L_{Profile chord}<xₚ<0.5L_{Profile chord}, wherein xₚ is the X-coordinate of the guide blade centre of rotation.

Particularly practically, the following relationship applies in a furthering embodiment with respect to the Y-coordinate y₃ of the high point P₃ and of the guide blade centre of rotation yₚ:

0≦yₚ/y₃≦1, preferentially 0≦y/y₃≦0.5,most preferably 0≦yₚ/y₃≦0.25.

In a furthering embodiment, the coordinates x₁, y₁ of the low point P₁ of the convex profile bottom side satisfy the following relationship:

0≦|y₁|/x₁≦1.5, preferentially 0.8≦|y₁|/x₁≦1.4, most preferably 1.0≦|y₁|/x₁≦1.3.

In an embodiment that is efficiency-optimised to a particular degree the following applies to the relationship between the respective X-coordinates of the guide blade centre of rotation xₚ and of the low point P₁ of the convex profile bottom side x₁:

0.8≦(xₚ−x₁)/xₚ, preferentially 0.9≦(xₚ−x1)/xₚ, most preferably 0.99≦(xₚ−x1)/xₚ.

In an embodiment that is alternative to this with likewise optimised efficiency, the following by contrast applies to the relationship between the respective X-coordinates xₚ, x₁ of the guide blade centre of rotation P and the low point P₁ of the convex profile bottom side x₁: (xₚ−x₁)/xₚ≦0.3, preferentially (xₚ−x₁)/xₚ≦0.2, most preferentially (xₚ−x₁)/xₚ≦0.1.

To further optimise the inflow of the guide blades, the geometry of the longitudinal profile of the guide blades satisfies the following relationships in a particularly preferred embodiment:

−0.7≦(xₚ−x₃)/xₚ≦0.7,

−1.5≦(xₚ−x₅)/xₚ≦1.5,

−0.7≦(xₚ−x₄)/xₚ≦0.7,

−1.7≦(xₚ−x₂)/xₚ≦1.7,

−2.0≦(xₚ−x₆)/xₚ≦1.7,

−1.5≦(x₂−x₅)/(x₆−x₂)≦1.5, and

−1.5≦(x₆−x₂)/(x₂−x₅)≦1.5.

Particularly practically, the centre line can be subdivided by the guide blade centre of rotation P into a first chord with chord length L₁ and a second chord with chord length L₂, wherein with an embodiment having a particularly high efficiency the following relationship then applies:

0.5≦L₁/L₂≦1.0,

preferentially 0.6L₁/L₂≦1.0,

most preferentially: 0.7≦L₁/L₂≦1.

The invention, furthermore, relates to a motor vehicle with an internal combustion engine and to an exhaust gas turbocharger interacting with the internal combustion engine having one or multiple of the features introduced above.

Further important features and advantages of the invention are obtained from the subclaims, from the drawings and from the associated figure description with the help of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

It shows, in each case schematically

FIG. 1a a rough schematic representation of an exhaust gas turbocharger according to the invention with variable turbine geometry in a part view,

FIG. 1b the variable turbine geometry of FIG. 1a in a detail view,

FIG. 2 a guide blade of the variable turbine geometry in a longitudinal profile,

FIG. 3 the longitudinal profile of FIG. 2 with respective construction circles defining a guide blade.

### DETAILED DESCRIPTION

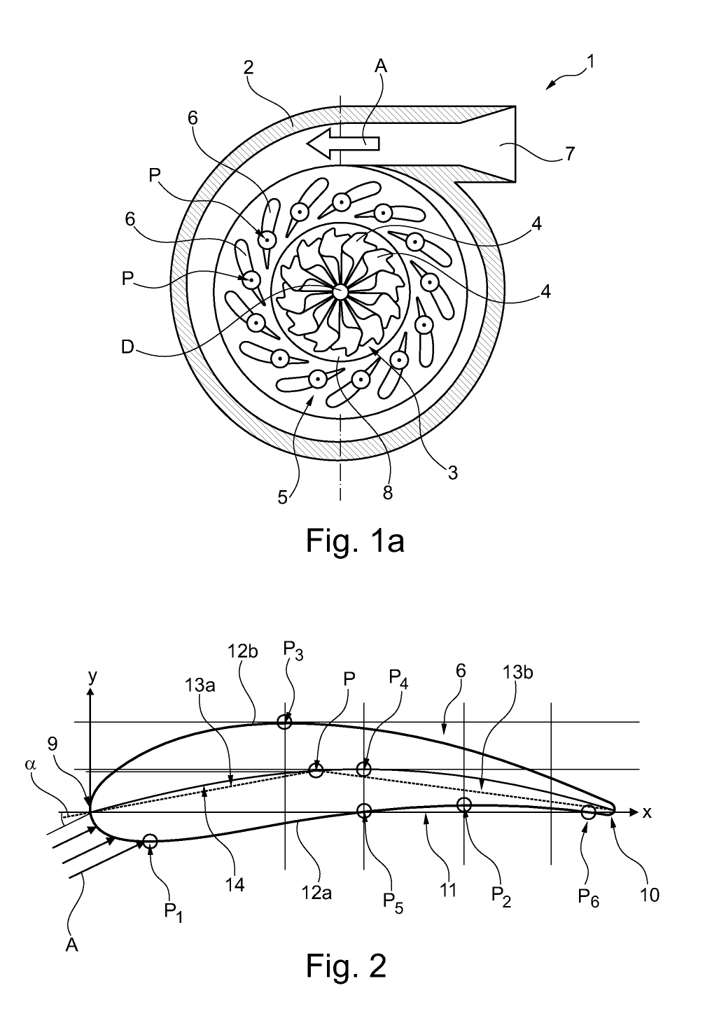

In FIG. 1a, an exhaust gas turbocharger according to the invention is shown in a rough schematic manner in a part view and marked with the reference character 1. The exhaust gas turbocharger 1 comprises a turbine housing 2 with a turbine wheel 3 comprising a first number of moving blades 4, which in the FIG. 1 are only shown in a rough schematic manner. The turbine wheel 3 is rotatable about a turbine wheel centre of rotation D relative to the turbine housing 2.

The exhaust gas turbocharger 1 furthermore comprises a variable turbine geometry 5, which comprises a blade bearing ring which is not shown in the schematic representation of FIG. 1, on which a second number of guide blades 6 is rotatably mounted in each case about a guide blade centre of rotation P. The second number of guide blade 6 in this case is distinct from the first number of moving blades 4. In the example shown in FIG. 1a, the turbine wheel 3 exemplarily comprises twelve moving blades 4 and the variable turbine geometry 5 thirteen guide blades 6; obviously, in version another number of guide blades 6 and moving blades 4 respectively is also possible.

For example, a variable turbine geometry 5 with eleven guide blades 6 and ten moving blades 4 is shown in a rough schematic manner for example in FIG. 1b. The guide blades 6 are adjustable between a closed position, in which a flow cross section between the guide blades 6 for exhaust gas to flow through is minimal and an opened position, in which this flow cross section is maximal.

In the example of FIG. 1a, the turbine housing 2 has a volute-like geometry as well as an inlet opening 7 and an outlet opening 8. By means of the turbine wheel 3 a high-pressure region which is fluidically connected to the inlet opening 7 is separated from a low-pressure region which is fluidically connected to the outlet opening 8.

For adjusting the guide blades 6 between the opened and the closed position, the variable turbine geometry 5 can comprise an adjusting element with a respective mounting which is not shown in the FIGS. 1a/b for the sake of clarity, wherein each guide blade 6 engages in such a mounting of the adjusting element via a respective adjusting lever. Obviously, other realisations for adjusting the guide blades 6 between the opened and the closed position or an intermediate position are also conceivable in versions.

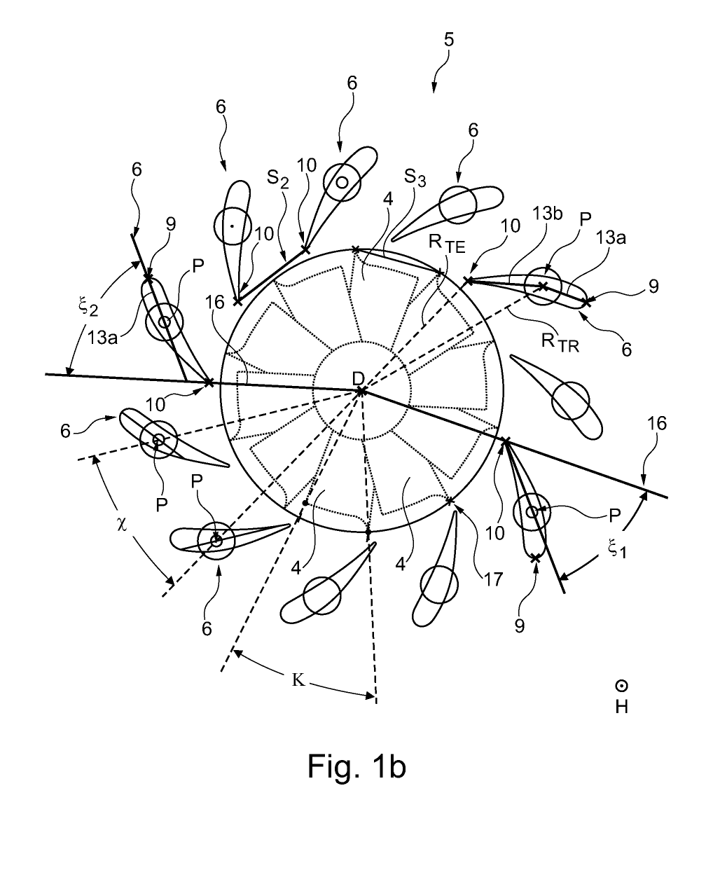

FIG. 2 now shows a guide blade 6 of the variable geometry 5 in a longitudinal section. The guide blade 6 in the longitudinal profile comprises a first profile nose 9 and a second profile nose 10. A profile chord 11 is defined by the connecting line between the two profile noses 9, 10.

From FIG. 1b it is evident in turn that the spacing R_{TE} of the second profile nose from the turbine wheel centre of rotation in the opened position of the guide blades and the radius of the turbine wheel R_{TR} according to the invention satisfy the following relationship:

1.03≦R_{TE}/R_{TR}≦1.06.

Such dimensioning of the variable turbine geometry 5 reduces undesirable excitation oscillations or oscillation loads on the guide blades 4 to a considerable degree which has a positive effect on the thermodynamic efficiency of the exhaust gas turbocharger 1. At the same time, the adjusting forces which are needed for moving the guide blades 4 are minimised. Similarly, the hysteresis behaviour of the variable turbine geometry 5 is minimised, as a result of which particularly good control behaviour can be achieved.

Particularly advantageous with respect to the efficiency that can be achieved is a version in which the spacing R_{TE} and the radius R_{TR} satisfy the following relationship:

1.04≦R_{TF}/R_{TR}≦1.06, preferentially even 1.05≦R_{TF}/R_{TR}≦1.06.

Again looking at the representation of FIG. 2 it is evident that in the longitudinal profile of the guide blade 6 its centre line 14 is subdivided by the guide blade centre of rotation P into a first chord 13a with chord length L₁ and a second chord 13b with chord length L₂. The first chord 13a in this case is defined by a connecting straight line of the guide blade centre of rotation P with the first profile nose 9 and the second chord 13b by a connecting straight line of the guide blade centre of rotation P with the second profile nose 10. In the example scenario of the figures, the guide blades 6 are now designed in such a manner that exhaust gas entering the turbine housing 2 strikes the guide blade 6 at an inflow angle α≦4° relative to the first chord 13a when the guide blades 6 are in their closed position.

FIG. 1b shows an angle ξ₂ between a connecting straight line 16 connecting the turbine wheel centre of rotation D and to the second profile nose 10 and the first chord 13a. In the exemplary scenario, is in the angle interval 35°≦ξ₂≦55°, in the case that the guide blades 6 are in the opened position and in the angle range 95°≦ξ₂≦110°, in the case that the guide blades 6 are in the closed position. In addition, an angle ξ₁ between the connecting straight line 16 connecting the turbine wheel centre of rotation D and the second profile nose 10 and the second chord 13b satisfies one of the two following relationships:

1.4≦ξ₂/ξ₁≦1.6, or 1.2≦ξ₂/ξ₁≦1.4.

The angle X formed as apex with respect to the turbine wheel centre of rotation D between two adjacent guide blade centres of rotation P and the opening angle κ of a moving blade 6 in the longitudinal section obey the following relationship:

0.4≦χ/κ≦2.4. In a version, 0.6≦χ/κ≦1.7, even applies, and in a particularly preferred version 0.9≦χ/κ≦1.2.

From FIG. 1b it is evident furthermore that the length S₂ of the connecting line of two adjacent second profile noses 10 in the opened state of the guide blade 6 and the inlet width S₃ between two adjacent moving blades 4 obey the following relationship: 0.45≦S₂/S₃≦3.2. In a version, 0.65≦S₂/S₃≦1.7, even applies, in a particularly preferred version 0.92≦S₂/S₃≦1.25. The ratio of a flow area A_{TR} (not shown in the figures) between two moving blades 4 with respect to the inlet area between two guide blades 6 A_{LS} (likewise not shown in the figures) obeys the following relationship: 0.36≦A_{LS}/A_{TR}≦3.82. In a version, 0.52≦A_{LS}/A_{TR}≦2.05, even applies. In a further version, even 0.74≦A_{LS}/A_{TR}≦1.5. Here, the inlet area A_{TR} between two moving blades 4 is defined by the relationship A_{TR}=h_{TR} S₃ and the inlet area A_{LS} between two guide blades 6 by the relationship A_{LS}=h_{LS} S₂. Here, h₂ is the height of the guide blades 6 along their axis of rotation in FIG. 1b, only the centre of rotation P is evident through which the axis of rotation runs and h₃ the height of the moving blade at the turbine wheel inlet, which in FIG. 1b has been exemplarily marked with the reference number 17 for a moving blade 4.

Finally, the following relationship applies to the ratio of a height h_{TR} of a moving blade 4 to the height h_{LS} of a guide blade 6: 0.8≦h_{LS}/h_{TR}≦1.2. Again 0.9≦h_{LS}/h_{TR}≦1.1 applies in a version. The mentioned heights h_{TR}, h_{LS} in this case relate to a vertical direction H arranged orthogonally to the drawing direction of the figures. For the ratio of a diameter D_{TR} of a moving blade 4 to the height h_{TR} of the moving blade 4 the following relationship applies: 0.1≦h_{TR}/D_{TR}≦0.2. In a preferred version, 0.12≦h_{TR}/D_{TR}≦0.18, applies and in a further version even 0.13≦h_{TR}/D_{TR}≦0.16.

In the example of the figures, an overlap of two adjacent guide blades 6 in the closed position and the length of a guide blade L_{LS} furthermore applies:

0.05*L_{LS}≦Δ≦0.4*L_{LS}, preferentially 0.1*L_{LS}≦Δ≦0.3*L_{LS}, most preferentially 0.15*L_{LS}≦Δ≦0.2*L_{LS}.

Here, Δ of the overlap region of two adjacent guide blades 6 extends in their longitudinal profile in their closed position, which consequently extends from a first profile nose 9 of a certain guide blade 6 as far as to the second profile nose 10 of the guide blade 6 that is adjacent to this guide blade 4.

As shown in FIG. 2, the guide blade 6 in the longitudinal profile can each have a profile bottom side 12a which in sections is formed in a convex manner and a profile top side 12b which is formed in a convex manner. The section of the profile bottom side 12a formed in a convex manner then has a low point P₁. Likewise, the section of the profile bottom side 12a formed in a concave manner has a high point P₂, the profile top side 12b a high point P₃.

From the representation of FIG. 2 it is also evident that the first profile nose 9 facing away from the turbine wheel 3 determines the original of a Cartesian coordinate system. An X-direction of this coordinate system is defined by the profile chord 11. Accordingly, a Y-direction of the coordinate system extends orthogonally to the X-direction away from the first profile nose 9. The spacing xₚ between first profile nose 9 and the guide blade centre of rotation P and the spacing x₁ between first profile nose 9 and low point P₁ in X-direction satisfy the following relationship:

(xₚ−x₁)/xₚ>0.8.

Accordingly, the spacing x₁ defined above and the spacing y₁ between first profile nose 9 and the low point P₁ satisfy the following relationship in Y-direction:

y₁/x₁≦0.4.

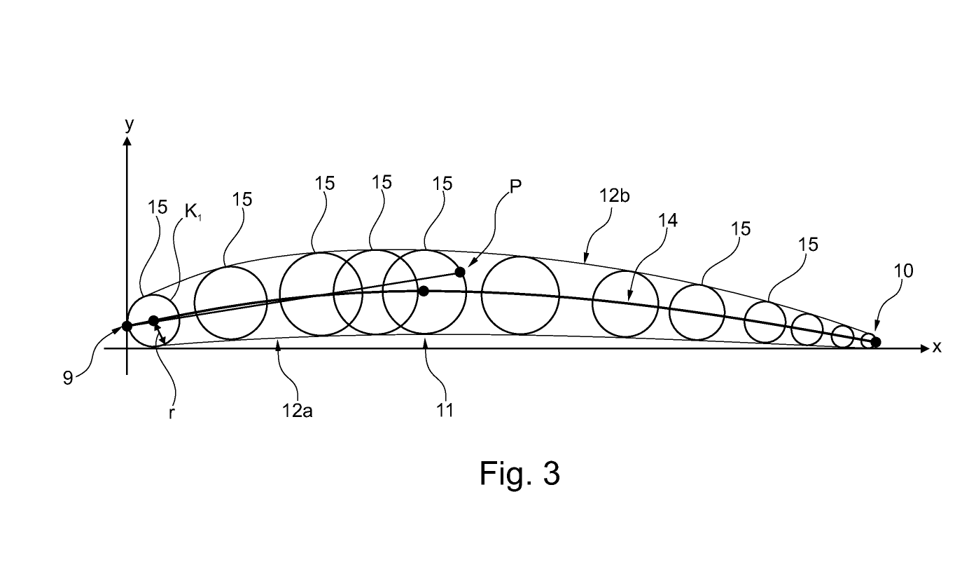

Looking now at the representation of FIG. 3, which shows the guide blade 6 analogously to FIG. 2 in a longitudinal profile it is evident that in the longitudinal profile of the guide blade 6 a centre line 14 is defined by a plurality of construction circles 15 between the profile top side 12b and the profile bottom side 12a. With respect to the radius r of the first construction circle K₁ defining the first profile nose 9 the condition r/xₚ>0.08 or r/xₚ<0.045 applies.

With respect to the X-coordinate xₚ of the guide blade centre of rotation P 0.03≦r/xₚ, preferentially 0.07≦r/xₚ, most preferentially 0.1≦r/xₚ applies in a version of the exemplary embodiment. In a version that is alternative to this,

r/xₚ≦0.4, preferentially r/xₚ≦0.38, most preferentially r/xₚ≦0.35 applies by contrast.

In the longitudinal profile of the guide blade 6 shown in the example of FIG. 3 the following relationships apply to the diameter k₁ of a first construction circle 15₁ assigned to the first profile nose 9, for the diameter k₂ of a first construction circle 15₂ assigned to the second profile nose 10 and the construction circle 15ₘₐₓ with maximum diameter kₘₐₓ:

1≦kₘₐₓ/k₁≦20, and 1≦kₘₐₓ/k₂≦10.

In the Cartesian coordinate system show in the FIGS. 2 and 3 the following points are thus defined as already explained above, by the X and Y-coordinates:
the Cartesian coordinates xₚ, yₚ of the guide blade centre of rotation P,
the Cartesian coordinates x₁, y₁ of the low point P₁ of the convex profile bottom side 12a,
the Cartesian coordinates x₂, y₂ of the high point P₂ of the concave profile bottom side 12a,
the Cartesian coordinates x₃, y₃ of the high point P₃ of the convex profile top side 12b.

Furthermore, an intersection P₅ of the convex profile bottom side 12a with the profile chord 11 is defined in the longitudinal profile of the guide blade 6 according to FIG. 2, which in the Cartesian coordinate system has the X and Y-coordinate x₅, y₅ respectively. Accordingly, an intersection P₆ of the concave profile bottom side 12a with the profile chord 11 is also defined in the longitudinal profile of the guide blades 6, which in the Cartesian coordinate system has the X and Y-coordinate x₆, y₆ respectively. Through the Cartesian coordinates x₄, y₄, a high point P₄ of the centre line 14 is defined.

The following relationships apply to the extreme points P₁, P₂, P₃, P₄, for the intersections P₅ and P₆ defined above and to the guide blade centre of rotation P of the guide blade 6 in the longitudinal profile shown in FIG. 2 which is improved compared with conventional guide blades:

−0.7≦(xₚ−x₃)/xₚ≦0.7,

−1.5≦(xₚ−x₅)/xₚ≦1.5,

−0.7≦(xₚ−x₄)/xₚ≦0.7,

−1.7≦(xₚ−x₂)/xₚ≦1.7,

−2.0≦(xₚ−x₆)/xₚ≦1.7,

−1.5≦(x₂−x₅)/(x₆−x₂)≦1.5,

−1.5≦(x₆−x₂)/(x₂−x₅)≦1.5.

At the same time the following applies:

0≦yₚ/y₄≦2;

0≦yₚ/y₁≦5;

0≦y₂/yₚ≦0.7;

0≦y₃/y₁≦5.

For the position of the spacing xₚ of the guide blade centre of rotation P from the first profile nose 9 in X-direction the following applies:

0.3L_{Profile chord}<xₚ<0.5L_{Profile chord},
wherein L_{Profile chord} is the length of the profile chord 11.

At the same time, the non-equation 0≦yₚ/y₃≦1 can apply to the Y-coordinate of the guide blade centre of rotation P relative to the Y-coordinate of the high point P₃ of the convex profile top side 12b. According to a preferred version even 0.6≦yₚ/y₃≦0.9, and according to a particularly preferred version 0.65≦yₚ/y₃≦0.73.

Furthermore, the following applies to the Cartesian coordinates x₁, y₁ of the first extreme point P₁. According to a preferred version the following applies: 0≦y₁/x₁≦0.4, preferentially 0≦x₁/y₁≦0.3, particularly preferably even 0≦y₁/x₁≦0.2. However, alternatively to this, the following relationships can also apply: 0.80≦y₁/x₁≦1.5, in a preferred version 0.90≦y₁/x₁≦1.3, most preferentially 1.0≦y₁/x₁≦1.1.

Furthermore, the relationship 0.8≦(xₚ x₁)/xₚ, preferentially 0.9≦(xₚ−x1)/xₚ, and most preferentially 0.99≦(xₚ−x₁)/xₚ can apply to the X-coordinate x₁ of the low point P₁ and the X-coordinate xₚ of the guide blade centre of rotation P. In a version which is alternative thereto, the guide blade 6 by contrast satisfies the following conditions in the longitudinal profile:

(xₚ−x₁)/xₚ≦0.3, preferentially(xp−x1)/xₚ≦0.2, most preferentially (xₚ−x₁)/xₚ≦0.1.

Looking at the longitudinal profile of FIG. 2 it is evident that the centre line 14 between profile bottom side 12a and profile top side 12b is subdivided by the guide blade centre of rotation P into the first chord 13a with chord length L₁ and into the second chord 13b with chord length L₂. The two chords 13a, 13b are connecting lines of the centre of rotation P with the first or second profile nose 9, 10. The relationship between L₁ and L₂ of the guide blade 6 in this case is 0.5≦L₁/L₂≦1.0. Preferentially, 0.6≦L₁/L₂≦1.0, most preferentially even 0.7≦L₁/L₂≦1 applies.

1. An exhaust gas turbocharger, comprising:
a turbine housing,
a turbine wheel including a first quantity of a plurality of moving blades, the turbine wheel being rotatable relative to the turbine housing about a turbine wheel centre of rotation and having a turbine wheel radius (R_{TR}),
a variable turbine geometry, including a blade bearing ring on which a second quantity of a plurality of guide blades are rotatably mounted in each case about a guide blade centre of rotation, wherein the plurality of guide blades are adjustable between a closed position, in which a flow cross section between the guide blades for an exhaust gas to flow through is at a minimum and an opened position, in which the flow cross section is at a maximum,
wherein each of the plurality of guide blades in a longitudinal profile includes a first profile nose facing away from the turbine wheel centre of rotation and a second profile nose facing the turbine wheel centre of rotation, and a straight connecting line between the first profile nose and the second profile nose defining a profile chord,
wherein a spacing (R_{TE}) of the second profile nose from the turbine wheel centre of rotation in the opened position of the guide blades and the turbine wheel radius (R_{TR}) satisfy the following relationship:
1.03≦R_{TE}/R_{TR}≦1.06.

2. The exhaust gas turbocharger according to claim 1, wherein the spacing (R_{TE}) and the turbine wheel radius (R_{TR}) satisfy the following relationship:
1.04≦R_{TE}/R_{TR}≦1.06.

3. The exhaust gas turbocharger according to claim 1, wherein:
the longitudinal profile of the respective guide blades includes a centre line, the centre line being divided by the guide blade centre of rotation into a first chord with a first chord length and a second chord with a second chord length, and
wherein the first chord is defined by a connecting straight line of the guide blade centre of rotation with the first profile nose and the second chord is defined by a connecting straight line of the guide blade centre of rotation with the second profile nose.

4. The exhaust gas turbocharger according to claim 3, wherein the plurality of guide blades are configured such that the exhaust gas entering the turbine housing strikes the guide blade at an inflow angle α<4° relative to the first chord when the guide blades are in the closed position.

5. The exhaust gas turbocharger according to claim 3, wherein an angle (ξ₂) between (i) a connecting straight line connecting the turbine wheel centre of rotation and the second profile nose and (ii) the first chord lies in the following angle interval:
35°≦ξ₂≦55°, in the case that when the guide blades are in the opened position, and
95°≦ξ₂≦110°, in the case that when the guide blades are in the closed position.

6. The exhaust gas turbocharger according to claim 3, wherein an angle (ξ₁) between (i) a connecting straight line connecting the turbine wheel centre of rotation and the second profile nose and (ii) the second chord satisfies at least one of the following relationships:
1.4≦ξ₂/ξ₁≦1.6, and
1.2≦ξ₂/ξ₁≦1.4.

7. The exhaust gas turbocharger according to claim 1, wherein an angle (χ) formed as an apex point with respect to the turbine wheel centre of rotation between two adjacent guide blade centres of rotation and an opening angle (κ) of one of the plurality of moving blades in a longitudinal section obey the following relationship:
0.4≦χ/κ≦2.4.

8. The exhaust gas turbocharger according to claim 1, wherein a length (S₂) of a connecting line between two adjacent second profile noses in the opened state of the guide blades and an inlet width (S₃) between two adjacent moving blades obey the following relationship:
0.45≦S₂/S₃≦3.2.

9. The exhaust gas turbocharger according to claim 1, wherein a ratio of a flow area (A_{TR}) between two moving blades with respect to an inlet area (A_{LS}) between two guide blades obeys the following relationship:
0.36≦A_{LS}/A_{TR}≦3.82.

10. The exhaust gas turbocharger according to claim 1, wherein a ratio of a height (h_{TR}) of one of the plurality of moving blades with respect to a height (h_{LS}) of one of the plurality of guide blades obeys the following relationship:
0.8≦h_{LS}/h_{TR}≦1.2.

11. The exhaust gas turbocharger according to claim 1, wherein a ratio of a diameter (D_{TR}) of at least one of the plurality of moving blades with respect to a height (h_{TR}) of the at least one of the plurality of moving blades obeys the following relationship:
0.1≦h_{TR}/D_{TR}≦0.2.

12. The exhaust gas turbocharger according to claim 1, wherein the longitudinal profile of at least one of the plurality of guide blades defines an X and Y-coordinate of the following points relative to a Cartesian coordinate system:
0≦yₚ/y₄≦2;
0≦yₚ/y₁≦5; and
0≦y₂/yₚ≦0.7; wherein:
xₚ, yₚ: Cartesian coordinates of the guide blade centre of rotation,
x₁, y₁: a low point of a bottom side having a convex profile,
x₂, y₂: a height of a bottom side having a concave profile,
x₃, y₃: a height of a top side having a convex profile,
x₄, y₄: a high point of a centre line of the longitudinal profile,
x₅, y₅: an intersection of the bottom side having the convex profile with the profile chord,
x₆, y₆: an intersection of the bottom side having the concave profile with the profile chord.

13. The exhaust gas turbocharger according to claim 1, wherein the longitudinal profile of at least one of the plurality of guide blades includes the following relationship:
0.3L_{Profile chord}<xₚ<0.5L_{Profile chord};
wherein L_{Profile chord} is a length of the profile chord, and xₚ is an X-coordinate of the guide blade centre of rotation relative to a Cartesian coordinate system.

14. The exhaust gas turbocharger according to claim 12, wherein the longitudinal profile of at least one of the plurality of guide blades includes the following relationship:
0≦yₚ/y₃≦1.

15. The exhaust gas turbocharger according to claim 12, wherein the longitudinal profile of at least one of the plurality of guide blades includes the following relationship:
0≦|y₁|/x₁≦1.5.

16. The exhaust gas turbocharger according to claim 1, wherein an angle (χ) formed as an apex point with respect to the turbine wheel centre of rotation between two adjacent guide blade centres of rotation and an opening angle (κ) of one of the plurality of moving blades in a longitudinal section obey the following relationship:
0.9≦χ/κ≦1.2.

17. The exhaust gas turbocharger according to claim 1, wherein a length (S₂) of a connecting line between two adjacent second profile noses in the opened state of the guide blades and an inlet width (S₃) between two adjacent moving blades obey the following relationship:
0.92≦S₂/S₃≦1.25.

18. The exhaust gas turbocharger according to claim 1, wherein a ratio of a flow area (A_{TR}) between two moving blades with respect to an inlet area (A_{LS}) between two guide blades obeys the following relationship:
0.74≦A_{LS}/A_{TR}≦1.5.

19. The exhaust gas turbocharger according to claim 1, wherein a ratio of a diameter (D_{TR}) of at least one of the plurality of moving blades with respect to a height (h_{TR}) of the at least one of the plurality of moving blades obeys the following relationship:
0.13≦h_{TR}/D_{TR}≦0.16.

20. An exhaust gas turbocharger for an internal combustion engine, comprising:
a turbine housing and a turbine wheel disposed therein rotatable relative to the turbine housing about a turbine wheel center of rotation, the turbine wheel including a turbine wheel radius (R_{TR}), wherein the turbine wheel includes a plurality of moving blades;
a variable turbine geometry including a blade bearing ring having a plurality of guide blades rotatably mounted about a guide blade centre of rotation, the plurality of guide blades adjustable between a closed position, in which a flow cross-section between the respective guide blades for an exhaust gas flow is at a minimum, and an opened position, in which the flow cross-section is at a maximum;
the plurality of guide blades respectively including a longitudinal profile, the longitudinal profile including:
a first profile nose facing away from the turbine wheel centre of rotation and a second profile nose facing the turbine wheel centre of rotation,
a first chord defined by connecting the guide blade centre of rotation with a straight line to the first profile nose along a centre line of the longitudinal profile, and a second chord defined by connecting the guide blade centre of rotation with a straight line to the second profile nose along the centre line;
wherein the second profile nose of the respective guide blades in the opened position includes a spacing (R_{TE}) between the turbine wheel centre of rotation and the turbine wheel radius (R_{TR}) satisfying the following relationship:
1.03≦R_{TE}/R_{TR}≦1.06; and
wherein the respective guide blades include (i) a first angle (ξ₂) between a connecting straight line, which connects the turbine wheel centre of rotation and the second profile nose, and the first chord, and (ii) a second angle (ξ₁) between the connecting straight line and the second chord;
the first angle (ξ₂) satisfying at least one of the following relationships:
35°≦ξ₂≦55° when the guide blades are in the opened position, and
95°≦ξ₂≦110° when the guide blades are in the closed position; and
the second angle (ξ₁) satisfying one of the following relationships:
1.4≦ξ₂/ξ₁≦1.6, and
1.2≦ξ₂/ξ₁≦1.4.
